(19) United States
(12) Patent Application Publication
(10) Pub. No.: US 2012/0173993 A1
(43) Pub. Date: Jul. 5, 2012

(54) POINT OF INTEREST PREVIEW FOR ELECTRONIC MAIL

(75) Inventors: AL CHAKRA, Apex, NC (US); Liam Harpur, Skerries (IE); Mark Kelly, Skerries (IE); John Rice, (US)

(73) Assignee: International Business Machines Corporation, Armonk, NY (US)

(21) Appl. No.: 12/982,316

(22) Filed: Dec. 30, 2010

(51) Int. Cl. G06F 3/01; G06F 15/16

(52) U.S. Cl. 715/752

(57) ABSTRACT

One or more interactions of a user are monitored. Information associated with the one or more interactions is indexed. A point of interested is determined within an electronic mail message based upon, at least in part, the indexed information. An indicator of the point of interest is provided within a preview pane associated with the electronic mail message.

### BACKGROUND OF THE DISCLOSURES

The present disclosure relates to electronic mail, and more particularly relates to previewing points of interest within an electronic mail message.

Electronic mail (email) is a very common means of communication. The wide-scale usage of email largely arises from email's convenience of use and speed of conducting communication. However, the popularity of email communication can often result in people being inundated with email, much of which may be of little interest or importance to a person. In an attempt to manage their email inboxes, users may often give email only a cursory review, often in an email application reviewing pane, to quickly decide whether an email is of any particular interest. As such, users may often delete important or interesting email because, upon their quick review, the email does not appear to be of interest. This can especially be the case with relatively long email, in which the interesting portion may not be in the beginning of the email.

### SUMMARY OF THE DISCLOSURE

According to a first implementation, a method includes monitoring, by a computing device, one or more interactions of a user. Information associated with the one or more interactions of the user are indexed. A point of interest is determined within an electronic mail message based upon, at least in part, the indexed information. An indicator of the point of interest is provided within a preview pane associated with the electronic mail message.

One or more of the following features may be included. The one or more interactions of the user may include one or more of, calendaring events, instant messaging interactions, email interactions, application usage, and internet usage. Indexing information associated with the one or more interactions of the user may include associating a weighting factor with the indexed information. Determining a point of interest within an electronic mail message may include determining a point of interest based upon, at least in part, the weighting factor associated with the indexed information.

Providing an indicator of the point of interest within the preview pane may include providing an indicator or a plurality of points of interest within the preview pane. The user may be allowed to toggle between the plurality of points of interest within the preview pane.

According to another implementation, a computer program product residing on a computer readable medium has a plurality of instructions stored one it. When executed by a processor, the instructions cause the processor to perform operations including monitoring one or more interactions of a user. Information associated with the one or more interactions of the user is indexed. A point of interest within an electronic mail message is determined based upon, at least in part, the indexed information. An indicator of the point of interest is provided within a preview pane associated with the electronic mail message.

One or more of the following features may be included. The one or more interactions of the user may include one or more of, calendaring events, instant messaging interactions, email interactions, application usage, and internet usage. The instructions for indexing information associated with the one or more interactions of the user may include instructions for associating a weighting factor with the indexed information. The instructions for determining a point of interest within an electronic mail message may include instructions for determining a point of interest based upon, at least in part, the weighting factor associated with the indexed information.

The instructions for providing an indicator of the point of interest within the preview pane may include instructions for providing an indicator or a plurality of points of interest within the preview pane. The computer program product may further include instructions for allowing the user to toggle between the plurality of points of interest within the preview pane.

According to another implementation, a system include a processor and a memory. A first software module is executable by the processor and the memory. The first software module is configure to monitor one or more interactions of a user. A second software module is executable by the processor and the memory. The second software module is configured to index information associated with the one or more interactions of the user. A third software module is executable by the processor and the memory. The third software module is configured to determine a point of interest within an electronic mail message based upon, at least in part, the indexed information. A fourth software module is executable by the processor and the memory. The fourth software module is configured to provide an indicator of the point of interest within a preview pane associated with the electronic mail message.

One or more of the following features may be included. The one or more interactions of the user include one or more of, calendaring events, instant messaging interactions, email interactions, application usage, and internet usage. The second software module, configured to index information associated with the one or more interactions of the user, may be further configured to associate a weighting factor with the indexed information. The third software module, configured to determine a point of interest within an electronic mail message, may be further configured to determine a point of interest based upon, at least in part, the weighting factor associated with the indexed information.

The fourth software module, configured to provide an indicator of the point of interest within the preview pane, may be further configured to provide an indicator or a plurality of points of interest within the preview pane. The system may include a fifth software module, which is executable by the processor and the memory. The fifth software module may be configured to allow the user to toggle between the plurality of points of interest within the preview pane.

The details of one or more implementations are set forth in the accompanying drawings and the description below. Other features will become apparent from the description, the drawings, and the claims.

### BRIEF DESCRIPTION OF THE SEVERAL VIEWS OF THE DRAWINGS

FIG. 1 diagrammatically depicts a preview process coupled to a distributed computing network.

FIG. 2 is a flowchart of a process executed by the preview process of FIG. 1.

FIG. 3 graphically depicts a user interface rendered by an email application alone, or in conjunction with the preview process of FIG. 1.

FIG. 4 graphically depicts a user interface rendered by an email application alone, or in conjunction with the preview process of FIG. 1.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium (also herein referred to as a computer readable medium and/or a storage device associated with a computing device or client electronic device) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable or computer-readable medium may be any non-transitory medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

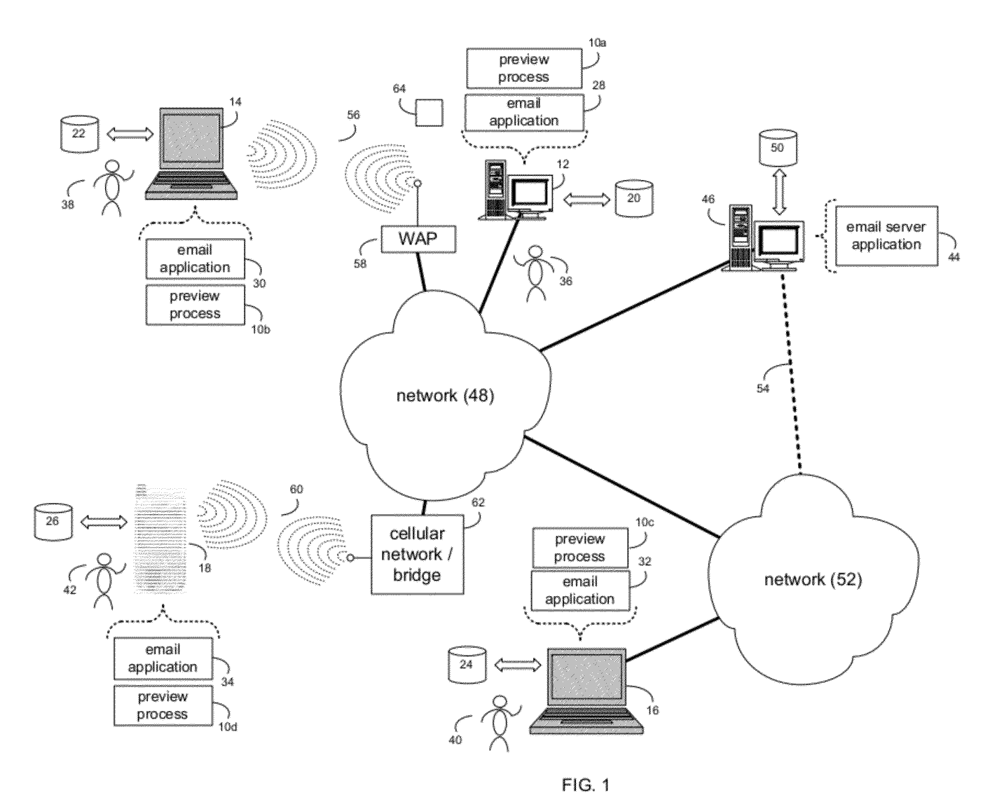

Referring to FIG. 1, there is shown preview process 10a-10d that may reside on and may be executed by client electronic devices 12, 14, 16, 18. Examples of client electronic devices 12, 14, 16, 18 may include, but are not limited to, personal computer 12, laptop computer 14, data enabled cellular telephone 16, notebook computer 18, for example. Client electronic devices 12, 14, 16, 18 may each execute an operating system, examples of which may include but are not limited to Microsoft® Windows®, Microsoft Windows CE®, Red Hat Linux, or a custom operating system (Microsoft and Windows are registered trademarks of Microsoft Corporation in the United States, other countries; Windows CE is a registered trademark of Microsoft Corporation in the United States, other countries, or both). The instruction sets and subroutines of preview process 10a-10d, which may be configured as one or more software modules, and which may be stored on storage device 20, 22, 24, 26 (respectively) coupled to client electronic device 12, 14, 16, 18 (respectively), may be executed by one or more processors (not shown) and one or more memory architectures (not shown) incorporated into client electronic device 12, 14, 16, 18 (respectively). Storage device 20, 22, 24, 26 may include, but are not limited to: hard disk drives; solid state drives, tape drives; optical drives; RAID arrays; random access memories (RAM); read-only memories (ROM), compact flash (CF) storage devices, secure digital (SD) storage devices, and memory stick storage devices.

As will be described in greater detail below, preview process 10a-10d may a monitor one or more interactions of a user. Information associated with the one or more interactions of the user are indexed. A point of interest is determined within an electronic mail message based upon, at least in part, the indexed information. An indicator of the point of interest is provided within a preview pane associated with the electronic mail message.

In addition to preview process 10a-10d, client electronic devices 12, 14, 16, 18 may each execute an electronic mail application (e.g., email applications 28, 30, 32, 34), examples of which may include, but are not limited to, e.g., Lotus Notes® and Microsoft Outlook® (Lotus Notes is a registered trademark of International Business machines Corporation in the United States, other countries, or both; and Outlook is a registered trademark of Microsoft Corporation in the United States, other countries, or both). Preview process 10a-10d may be a stand alone application that interfaces with the respective email application 28, 30, 32, 34, and/or may be an applet/application that is executed within email application 28, 30, 32, 34, a module of email application 28, 30, 32, 34, or the like.

Using email applications 28, 30, 32, 34, one or more users (e.g., users 36, 38, 40, 42) may access email server application 44, examples of which may include, but are not limited to e.g., IBM® Lotus® Domino® Server and Microsoft Exchange® Server (IBM, Lotus, and Domino are registered trademarks of International Business Machines Corporation in the United States, other countries or both; Exchange is a registered trademark of Microsoft Corporation in the United States, other countries or both). Email server application 44 may route electronic mail messages to email client applications, e.g., email client applications 28, 30, 32, 34, thereby allowing users 36, 38, 40, 42 to engage in various electronic mail interactions.

Email server application 44 may be executed by server computer 46, which may be connected to network 48 (e.g., the Internet or a local area network). Examples of server computer 46 may include, but are not limited to: a personal computer, a server computer, a series of server computers, a mini computer, and a mainframe computer. Server computer 46 may be a web server (or a series of servers) running a network operating system, examples of which may include but are not limited to: Microsoft® Windows® Server; Novell® Netware®; or Red Hat® Linux®, for example (Microsoft and Windows are registered trademarks of Microsoft Corporation in the United States, other countries, or both; Novell and NetWare are registered trademarks of Novell Corporation in the United States, other countries, or both; Red Hat is a registered trademark of Red Hat Corporation in the United States, other countries, or both; and Linux is a registered trademark of Linus Torvalds in the United States, other countries, or both).

The instruction sets and subroutines of email server application 44, which may include one or more software modules and which may be stored on storage device 50 coupled to server computer 46, may be executed by one or more processors (not shown) and one or more memory architectures (not shown) incorporated into server computer 46. Storage device 50 may include but is not limited to: a hard disk drive; a solid state drive; a tape drive; an optical drive; a RAID array; a random access memory (RAM); and a read-only memory (ROM).

Server computer 46 may execute a web server application, examples of which may include but are not limited to: Microsoft IIS, Novell Webserver™, or Apache® Webserver, that allows for HTTP (i.e., HyperText Transfer Protocol) access to server computer 46 via network 48 (Webserver is a trademark of Novell Corporation in the United States, other countries, or both; and Apache is a registered trademark of Apache Software Foundation in the United States, other Countries, or both). Network 48 may be connected to one or more secondary networks (e.g., network 52), examples of which may include but are not limited to: a local area network; a wide area network; or an intranet, for example.

In addition/as an alternative to being a client-based application residing on server client electronic devices 12, 14, 16, 18, the preview process may be a server-side application (not shown) residing on server computer 46 (e.g., stored on storage device 50, and executed by a processor (not shown) and memory architecture (not shown) incorporated into server computer 46. The server-side availability process may be a stand alone application that interfaces with an email server application (e.g., email server application 44), or may be an applet/application that is executed within an email server application. As such, the preview process may be a client-side application, a server-based application, or a hybrid client-side/server-based application, which may be executed, in whole or in part, by server computer 46, and/or one or more of client electronic device (e.g., client electronic devices 12, 14, 16, 18).

Users 36, 38, 40, 42 may access email server application 44 directly through the device on which the email application (e.g., email applications 28, 30, 32, 34) is executed, namely client electronic devices 12, 14, 16, 18, for example. Users 36, 38, 40, 42 may access email server application 44 directly through network 48 or through secondary network 52. Further, server computer 46 (i.e., the computer that executes email server application 44) may be connected to network 48 through secondary network 52, as illustrated with phantom link line 54.

The various client electronic devices may be directly or indirectly coupled to network 48 (or network 52). For example, personal computer 12 is shown directly coupled to network 48 via a hardwired network connection. Further, notebook computer 14 is shown directly coupled to network 52 via a hardwired network connection. Laptop computer 16 is shown wirelessly coupled to network 48 via wireless communication channel 56 established between laptop computer 16 and wireless access point (i.e., WAP) 58, which is shown directly coupled to network 48. WAP 58 may be, for example, an IEEE 802.11a, 802.11b, 802.11g, Wi-Fi, and/or Bluetooth device that is capable of establishing wireless communication channel 56 between laptop computer 16 and WAP 58. Data enabled cellular telephone 18 is shown wirelessly coupled to network 48 via wireless communication channel 60 established between data enabled cellular telephone 18 and cellular network/bridge 62, which is shown directly coupled to network 48.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

In addition to email applications 28, 30, 32, 34, client electronic devices 12, 14, 16, 18 may execute various additional applications (not shown). Such additional applications may include, but are not limited to, calendaring or scheduling applications, instant messaging applications, web browsers, debugging applications, electronic meeting applications, etc. The various additional applications, which may be executed by client electronic device 12, 14, 16, 18 will be readily appreciated by those having skill in the art.

For the purpose of the following description, preview process 10a and email application 28 may be discussed. However, this is for illustrative purposes only and should not be construed as a limitation of the present disclosure, as other preview processes (e.g., preview processes 10b-10d) and other email applications (e.g., email applications 30, 32, 34) may be equally utilized.

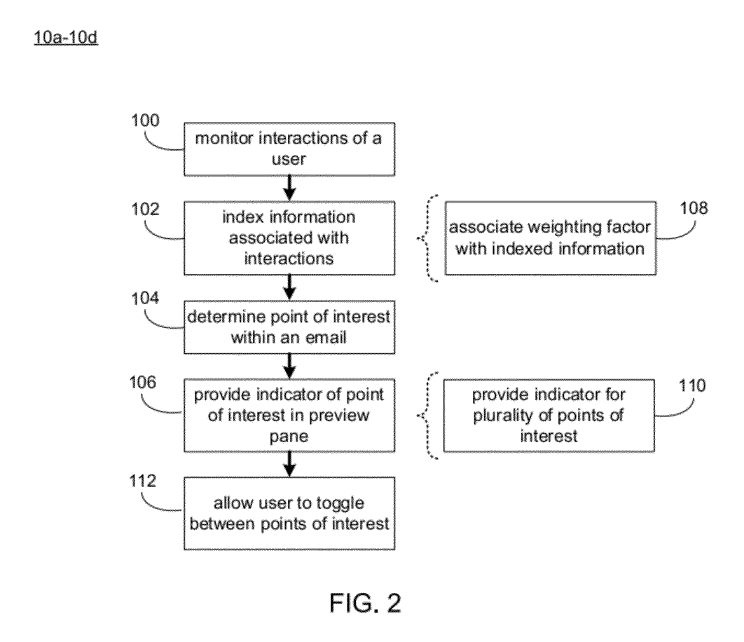

Referring also to FIG. 2, preview process (e.g., preview process 10a executed on client electronic device 12) generally may monitor 100 one or more interactions of a user. Preview process 10a may further index 102 information associated with the one or more interactions of the user. Preview process 10a may also determine 104 a point of interest within an electronic mail message based upon, at least in part, the indexed information. Preview process 10 a may provide 106 an indicator of the point of interest within a preview pane associated with the electronic mail message.

Assume, for example, that a user (e.g., user 36) engages in various activities during the course of his day. Preview process 10a may monitor 100 user 36's interactions occurring through the various activities. The one or more interactions of user 36 may include one or more of, e.g., calendaring events, instant messaging interactions, email interactions, application usage, and internet usage. For example, using a calendaring application (not shown) user 38 may accept a meeting invitation for the following day. The topic assigned to the accepted meeting invitation may be “cloud computing.” Similarly, user 38 may maintain a blog about “furniture making,” which may be accessed, updated, etc., using a web browser (not shown). Further, assume that user 38 frequently has a Visual C++ debugging application running on client electronic device 12. Preview process 10a may monitor 100 these (as well various additional/alternative interactions, such as instant messaging conversations, email communications, to-do lists, accessed documents, etc.) interactions.

Through monitoring 100 the various interactions preview process 10a may acquire information associated with the one or more interactions of user 38 (e.g., keywords, phrases, and/or topics contained in accessed documents, scheduled meetings, web pages visited, to-do lists, etc.; applications utilized; and the like). Continuing with the above stated example, preview process 10a may acquire the keyword “cloud computing” based upon the accepted meeting invitation. Additionally, preview process 10a may associate a time frame of the following day with the keyword “cloud computing” based upon the time of the scheduled meeting. Similarly, preview process 10a may acquire the topic “furniture making” based upon the blog maintained and accessed by user 38. Preview process 10a may also associate a frequency (e.g., once a week) of access with the topic “furniture making,” based upon how often user 38 accessed the blog. As also described above, preview process 10a may acquire the information “C++ debugging” based upon user 38's relatively frequent use of a Visual C++ debugger. Preview process 10a may also associate the information three hours a day with “C++ debugging” based upon a typical usage of the Visual C++ debugging by user 38.

Preview process 10a may index 102 information associated with the one or more interaction of user 38. As discussed above, various information may be directly, and/or indirectly, ascertained from the interactions of user 38. Preview process 10a may index 102 the information associated with the interactions of user 38, e.g., by storing the information in a database or other suitable repository. The database (not shown), or other index, may be locally stored on client electronic device 12 (e.g., on storage device 20). Additionally/alternatively, the database (not shown), or other repository may be stored on server computer 46 (e.g., on storage device 50). The index of information associated with the one or more interactions of the user may be searchable by preview process 10a (and/or by another application, such as email application 28).

Indexing 102 information associated with the one or more interactions of the user may include associating 108 a weighting factor with the indexed 102 information. The information indexed 102 by preview process may represent information that has some relevance, interest, or importance to the user, e.g., by virtue of being information associated with one or more interactions of the user. Continuing with the above stated example, “cloud computing” may represent information that has some relevance, interest, or importance to user 38, otherwise user 38 likely would not have accepted the invitation to a meeting having cloud computing as the meeting topic. Similarly, C++ debugging may represent some relevance, interest, or importance to user 38 based upon the amount of time user 38 spends running a Visual C++ debugging application. Preview process 10a may index 102 this information having relevance, interest, or importance to user 38. Further, preview process 10a may associate 108a weighting factor with the indexed 102 information. The weighting factor associated 108 with the information may be indicative of a level of relevance, interest, or importance.

Preview process 10a may associate 108 a weighting factor with the indexed 102 information based upon any variety of factors, and/or combination of factors. For example, preview process 10a may associate 108 a weighting factor with the indexed 102 information based upon, at least in part, a temporal consideration. Continuing with the above stated example, in which user 38 has accepted a meeting for tomorrow, given the relatively immediate temporal proximity preview process 10a may associate 108 a relatively high relevance weighting factor with cloud computing. Similarly, given user 38's frequency of accessing the blog about furniture making (e.g., once a week), preview process may associate 108 a moderate relevance weighting factor. Similarly, based upon user 38's relatively frequent usage of a Visual C++ debugging application (e.g., three hours a day in the above example), preview process 10a may associate 108 a moderately high relevance weighting factor.

As mentioned various additional/alternative considerations may also be utilized in associating 108 a weighting factor with the indexed 102 information. For example, while user 38 may only access the furniture making blog once a week, user 38 may have been accessing the furniture making blog consistently for the past year. The regular access of the furniture making blog over the last year may indicate a heightened degree of relevance to user 38. As such, preview process 10a may associate 108 a higher weighting factor with the topic “furniture making” than would be the case if user 38 had accessed the furniture making blog once a week over only the last month. Preview process 10a may utilize many further considerations in associating 108 a weighting factor with the indexed 102 information. Further, preview process 10a may allow user 38 to customize, or adjust, the weighting factors associated 108 with various indexed 102 information. The weighting factors associated 108 with indexed 102 information may also be stored in a database, or other suitable format. In this regard, preview process 10a may include user preference settings, which may allow a user to customize various attributes, such as interactions to monitor 100, associated 108 weighting factors, as well as various other settings depending upon design criteria and user preference.

Additionally, with regard to user preference settings, a user may not only manually assign/adjust a weighting factor associated 108 with a piece of information, preview process 10a may allow a user to add (or remove or modify) one or more items of information to the index. As such, even if a topic, keyword, etc., may not be evident from other interactions of the user, preview process may monitor 100 user customization of the index as an interaction of the user. In a similar manner, preview process 10a may index 102 the information associated with such an interaction (i.e., the user customization of the index) by saving the user input to the index.

Preview process 10a may determine 104 a point of interest within an electronic mail message based upon, at least in part, the indexed 102 information. For example, user 38 may receive, via email client application 28 and email server application 44, an email message (e.g., email message 64 shown in FIG. 1). Preview process 10a may determine 104 a point of interest within the email by comparing the contents of the index (i.e., the repository including information associated with the one or more interactions of the user) with the email message. Matches between the index of information associated with interactions of user 38 and the email may constitute points of interest (i.e., items that may be relevant, interesting, or important to user 38). Continuing with the above-stated example, assume that email message 64 includes the phrase “cloud computing.” “Cloud computing” may be included within the index of information associated with interactions of user 38 as a result of the scheduled meeting including the topic “cloud computing.” Preview process 10a may determine 104 a point of interest (namely “cloud computing”) within email message 64 based upon, at least in part, the phrase “cloud computing” being present in both email message 64 and the index of information associated with the one or more interactions of user 38. In a similar manner, email message 64 may include the term “C++.” Based upon, at least in part, user 38's relatively frequent usage of a Visual C++ debugging application (which may be reflected in the index of information associated with the one or more interactions of user 38), preview process 10a may determine 104 that the term “C++” within email message 64 is also a point of interest.

Further, determining 104 a point of interest within an electronic mail message may include determining 104 a point of interest based upon, at least in part, the weighting factor associated 108 with the indexed 102 information. For example, preview process 10a may be configured to allow a user to define a threshold weighting factor for a piece of information to result in a determination 104 point of interest. As such, information having a relatively low associated 108 weighting factor may not result in preview process 10a determining 104 a point of interest within an email message. Such thresholds may be set by default and/or via user preference settings (discussed above). Further, in the event that preview process 10a may determine 104 that an email message includes more than one point of interest, preview process 10a may rank the various points of interest based upon, at least in part, the respective weighting factors associated with each point of interest.

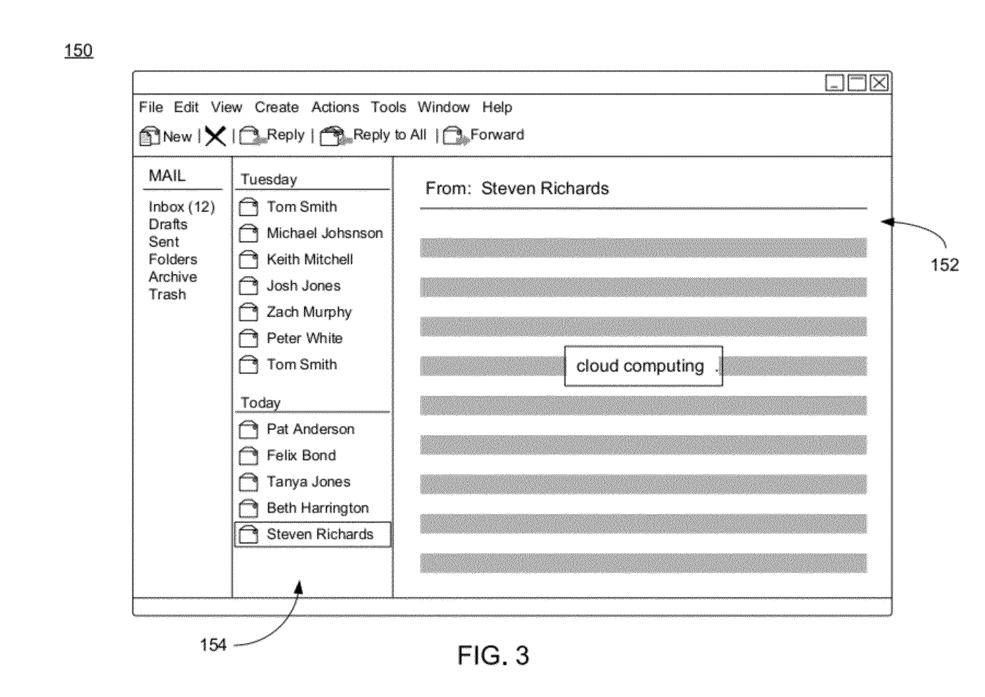

Preview process 10a may provide 106 an indicator of the point of interest within the email within a preview pane associated with the electronic mail message. Preview process 10a may provide 106 various indicators of the point of interest within email message 64. For example, and referring also to FIG. 3, email application 28 (alone or in conjunction with preview process 10a) may render email user interface 150. Email user interface 150 may include preview pane 152, which may display email message 64 (e.g., when email message 64 is a selected email in email listing 154). As is generally known, preview pane 152 of email interface 150 may allow a user (e.g., user 36) to preview an email (e.g., via email application 28) selected in email listing 154 without actually opening the selected email (e.g., in which opening the email may be accomplished by, for example, double-clicking on the email using a pointing device such as a mouse). Preview process 10a may, for example, highlight the term “cloud computing,” as shown in FIG. 3. Additionally, in the case of a multipage email (e.g., an email message which may span more than a single page of the preview pane 152, preview process 10a may scroll email message 64 within preview pane 152 such that the indicated 106 point of interest within email message 64 is displayed within preview pane 152 (e.g., without the need for user 38 to scroll through email message 64 to locate the point of interest “cloud computing”). Various additional/alternative mechanisms may be utilized to indicate the point of interest within the email message. In the foregoing manner, a user may be able to quickly identify if the email message includes any points of interest that may be of particular interest to the user. As such, even in the case of a relatively long email, the user may be quickly directed to items that may be relevant, interesting, or important to the particular user.

Providing 106 an indicator of the point of interest within the preview pane may include providing 110 an indicator or a plurality of points of interest within the preview pane. For example, as discussed above, preview process 10a may determine 104 that email message 64 includes multiple points of interest for user 38 (namely “cloud computing” and “C++” in the foregoing example). Preview process 10a may provide 110 an indicator for each of the plurality of points of interest within the email message.

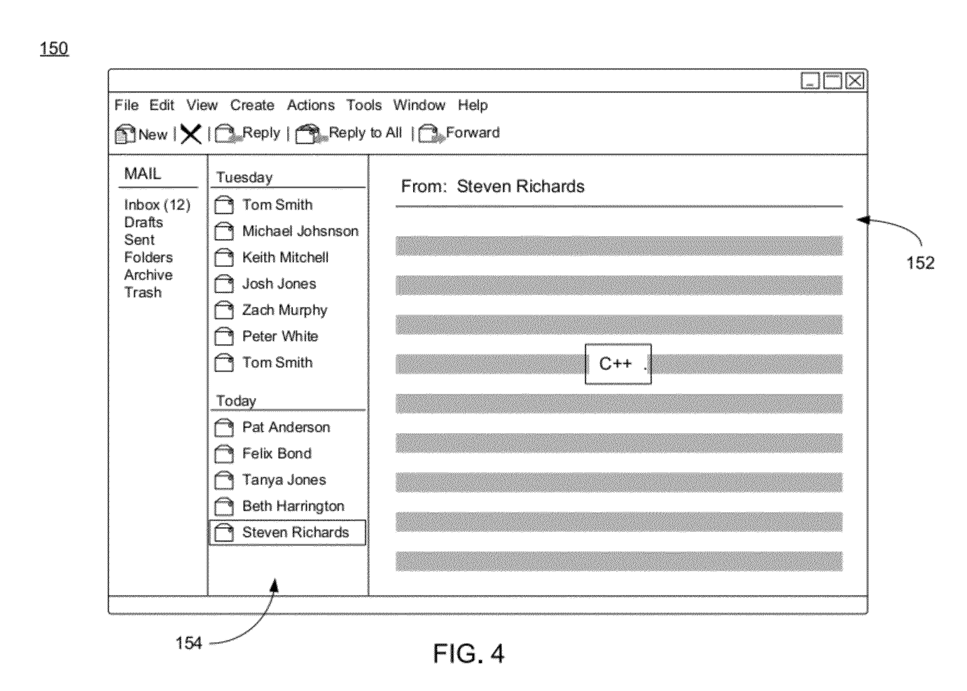

Continuing with the above situation in which an email message may include more than one indicated 110 points of interest, preview process 10a may allow 112 the user to toggle between the plurality of points of interest within the preview pane. For example, and referring also to FIG. 4, user 38 may toggle to a subsequent point of interest within email message 64 by utilizing a “next” functionality. The “next” functionality may be invoked, for example, by pressing a down arrow key on a keyboard associated with client electronic device 12, scrolling downwardly with a center wheel of a mouse (not shown) associated with client electronic device 12, or any other suitable means based upon design criteria or user need. Invoking the “next” functionality may result in preview process 10a toggling to the next indicated 112 point of interest. For example, in a multipage email message, rather than scrolling through the email message to identify if there are any other indicated points of interest, the user may invoke the “next” functionality resulting in preview process 10a toggling to the next indicated point of interest. In this manner email message 64 displayed in preview pane 152 may skip ahead to the next indicated 110 point of interest. It should be noted that the toggling aspect may, in some embodiments, operate in a bidirectional manner. As such, invoking a “previous” functionality (e.g., pressing an up arrow key, scrolling upwardly on a mouse, etc.) may result in preview process toggling to a previous indicated 110 point of interest within email message 64. Various additional/alternative implementations may be equally utilized.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer implemented method comprising:
monitoring, by a computing device, one or more interactions of a user;
indexing, by the computing device, information associated with the one or more interactions of the user;
determining, by the computing device, a point of interest within an electronic mail message based upon, at least in part, the indexed information; and
providing, by the computing device, an indicator of the point of interest within a preview pane associated with the electronic mail message.

2. The computer implemented method according to claim 1, wherein the one or more interactions of the user include one or more of, calendaring events, instant messaging interactions, email interactions, application usage, and internet usage.

3. The computer implemented method according to claim 1, wherein indexing information associated with the one or more interactions of the user includes associating a weighting factor with the indexed information.

4. The computer implemented method according to claim 3, wherein determining a point of interest within an electronic mail message includes determining a point of interest based upon, at least in part, the weighting factor associated with the indexed information.

5. The computer implemented method according to claim 1, wherein providing an indicator of the point of interest within the preview pane includes providing an indicator of a plurality of points of interest within the preview pane.

6. The computer implemented method according to claim 5, further including allowing the user to toggle between the plurality of points of interest within the preview pane.

7. A computer program product residing on a computer readable medium having a plurality of instructions stored thereon, which, when executed by a processor, cause the processor to perform operations comprising:
monitoring one or more interactions of a user;
indexing information associated with the one or more interactions of the user;
determining a point of interest within an electronic mail message based upon, at least in part, the indexed information; and
providing an indicator of the point of interest within a preview pane associated with the electronic mail message.

8. The computer program product according to claim 7, wherein the one or more interactions of the user include one or more of, calendaring events, instant messaging interactions, email interactions, application usage, and internet usage.

9. The computer program product according to claim 7, wherein the instructions for indexing information associated with the one or more interactions of the user include instructions for associating a weighting factor with the indexed information.

10. The computer program product according to claim 9, wherein the instructions for determining a point of interest within an electronic mail message include instructions for determining a point of interest based upon, at least in part, the weighting factor associated with the indexed information.

11. The computer program product according to claim 7, wherein the instructions for providing an indicator of the point of interest within the preview pane include instructions for providing an indicator of a plurality of points of interest within the preview pane.

12. The computer program product according to claim 11, further including instructions for allowing the user to toggle between the plurality of points of interest within the preview pane.

13. A system comprising:
a processor;
a memory;
a first software module executable by the processor and the memory, the first software module configure to monitor one or more interactions of a user;
a second software module executable by the processor and the memory, the second software module configured to index information associated with the one or more interactions of the user;
a third software module executable by the processor and the memory, the third software module configured to determine a point of interest within an electronic mail message based upon, at least in part, the indexed information; and
a fourth software module executable by the processor and the memory, the fourth software module configured to provide an indicator of the point of interest within a preview pane associated with the electronic mail message.

14. The system according to claim 13, wherein the one or more interactions of the user include one or more of, calendaring events, instant messaging interactions, email interactions, application usage, and internet usage.

15. The system according to claim 13, wherein the second software module, configured to index information associated with the one or more interactions of the user, is further configured to associate a weighting factor with the indexed information.

16. The system according to claim 15, wherein third software module, configured to determine a point of interest within an electronic mail message, is further configured to determine a point of interest based upon, at least in part, the weighting factor associated with the indexed information.

17. The system according to claim 13, wherein the fourth software module, configured to provide an indicator of the point of interest within the preview pane, is further configured to provide an indicator of a plurality of points of interest within the preview pane.

18. The system according to claim 17, further including a fifth software module, executable by the processor and the memory, the fifth software module configured to allow the user to toggle between the plurality of points of interest within the preview pane.
